(19) United States
(12) Patent Application Publication
(10) Pub. No.: US 2026/0127215 A1
(43) Pub. Date: May 7, 2026

(54) ANALYSIS AND CLUSTERING OF UNSTRUCTURED COMPUTER TEXT FOR GENERATION OF A STRUCTURED CONVERSATION FLOW FOR A CONVERSATION SERVICE APPLICATION

(71) Applicant: FMR LLC, Boston, MA (US)

(72) Inventors: Pinky Budania, Bangalore (IN); Nitin Kumar, Mahadevapura (IN); Siddharth Thakur, Bengaluru (IN); Ankit Garg, Bangalore (IN); Bidhan Roy, Bangalore (IN)

(21) Appl. No.: 18/937,475

(22) Filed: Nov. 5, 2024

(51) Int. Cl. G06F 16/35; G06F 40/166; G06F 40/279; G06F 40/35; G06F 40/40

(52) U.S. Cl. CPC G06F 16/355; G06F 40/166; G06F 40/279; G06F 40/35; G06F 40/40

(57) ABSTRACT

Methods and apparatuses in which unstructured computer text is analyzed for generation of a structured conversation flow for a conversation service application include a server that extracts a sequence of questions from historical voice call transcripts. The server converts each of the extracted questions into a multidimensional embedding using a sentence transformer. The server clusters the multidimensional embeddings into question clusters using a similarity measure algorithm. Each of the question clusters is assigned a cluster identification label. The server generates, for each historical voice call transcript, a sequence of cluster identification labels corresponding to the sequence of questions. The server creates a conversation flow graph for each historical voice call transcript based upon the associated sequence of cluster identification labels.

### TECHNICAL FIELD

This application relates generally to methods and apparatuses, including computer program products, for analysis and clustering of unstructured computer text for generation of a structured conversation flow for a conversation service application.

### BACKGROUND

Recent advances in artificial intelligence (AI)-based computer technology enable systems to automatically parse large corpuses of unstructured computer text, convert the text into computer-readable representations, and execute one or more machine learning algorithms on the output to gain various actionable insights. One area where these techniques can be particularly useful is customer relationship management (CRM) and customer service. In one example, customer contact call centers often record most, if not all, incoming calls between a customer and an agent, and the corresponding call transcript is frequently converted into unstructured computer text and stored in a database for data analysis and data mining.

However, in a typical customer contact environment, conversation flows that occur on live calls between customers and agents can vary significantly from conversation flows executed by automated conversation service applications-such as interactive voice response (IVR) systems, chatbots, and/or virtual assistants. In such cases, it may be determined that the conversation flows occurring in the voice calls are more efficient in resolving customer questions, leading to increased customer satisfaction or engagement, or otherwise providing an improved customer experience. Call flow designers and conversation analysts typically do not generate conversation flows that cover all possible scenarios and/or sufficiently promote increased customer engagement. As a result, it is important to utilize advanced computing systems to understand and extract voice call question flows that lead to successful customer interactions and to integrate those flows seamlessly into the corresponding conversation service software applications.

### SUMMARY

Therefore, what is needed are methods and systems that utilize a large corpus of historical voice call transcript data in an artificial intelligence framework to generate conversation flow graphs which can then be used to modify and improve conversation flows for automated conversation service applications. The techniques described herein provide the technical advantage of machine learning-based question extraction and clustering from historical voice call transcripts to automatically create graph data structures that reflects the sequence of questions in one or more transcripts. The methods and systems can leverage the graph data structures to dynamically adapt conversation flows of software-based conversation appliances (e.g., interactive voice response systems, chatbots, virtual assistants, guided service applications).

The invention, in one aspect, features a system used in a computing environment in which unstructured computer text is analyzed for generation of a structured conversation flow for a conversation service application. The system includes a server computing device having a memory for storing computer-executable instructions and a processor that executes the computer-executable instructions. The server computing device extracts a sequence of questions from each of a plurality of historical voice call transcripts by executing, using the processor, a combined rule-based and natural language processing machine learning model on the plurality of historical voice call transcripts. The server computing device converts each of the extracted questions into a multidimensional embedding using a sentence transformer machine learning model. The server computing device clusters the multidimensional embeddings into one or more question clusters using a similarity measure algorithm, each of the question clusters assigned a cluster identification label. The server computing device generates, for each historical voice call transcript, a sequence of cluster identification labels corresponding to the sequence of questions extracted from the call transcript. The server computing device creates a conversation flow graph for each historical voice call transcript based upon the associated sequence of cluster identification labels.

The invention, in another aspect, features a computerized method in which unstructured computer text is analyzed for generation of a structured conversation flow for a conversation service application. A server computing device extracts a sequence of questions from each of a plurality of historical voice call transcripts by executing, using the processor, a combined rule-based and natural language processing machine learning model on the plurality of historical voice call transcripts. The server computing device converts each of the extracted questions into a multidimensional embedding using a sentence transformer machine learning model. The server computing device clusters the multidimensional embeddings into one or more question clusters using a similarity measure algorithm, each of the question clusters assigned a cluster identification label. The server computing device generates, for each historical voice call transcript, a sequence of cluster identification labels corresponding to the sequence of questions extracted from the call transcript. The server computing device creates a conversation flow graph for each historical voice call transcript based upon the associated sequence of cluster identification labels.

Each of the above aspects can include one or more of the following features. In some embodiments, the server computing device modifies a conversation flow of the conversation service application using the conversation flow graph. In some embodiments, modifying a conversation flow of the conversation service application comprises rearranging a sequence of prompts in a conversation flow of the conversation service application, adding one or more prompts to a conversation flow of the conversation service application, removing one or more prompts from a conversation flow of the conversation service application, or changing content of one or more prompts in a conversation flow of the conversation service application. In some embodiments, the conversation service application comprises a chatbot application, an interactive voice response (IVR) application, a virtual assistant application, or a guided service application.

In some embodiments, the server computing device preprocesses the plurality of historical voice call transcripts before executing the combined rule-based and natural language processing machine learning model on the plurality of historical voice call transcripts. In some embodiments, preprocessing the plurality of historical voice call transcripts comprises replacing one or more regular expressions in the historical voice call transcripts with default values, detecting boundaries between sentences in the historical voice call transcripts, and inserting punctuation at each sentence boundary in the historical voice call transcripts. In some embodiments, the server computing device executes a natural language processing model to replace the regular expressions and the server computing device executes a large language model to detect the boundaries and insert the punctuation.

In some embodiments, the similarity measure algorithm comprises a k-means clustering algorithm or an hdbscan algorithm. In some embodiments, the conversation flow graph comprises a data structure with a plurality of nodes connected via edges and arranged according to the sequence of cluster identification labels. In some embodiments, the server computing device merges at least two of the conversation flow graphs to generate an aggregate conversation flow graph.

Other aspects and advantages of the invention will become apparent from the following detailed description, taken in conjunction with the accompanying drawings, illustrating the principles of the invention by way of example only.

### BRIEF DESCRIPTION OF THE DRAWINGS

The advantages of the invention described above, together with further advantages, may be better understood by referring to the following description taken in conjunction with the accompanying drawings. The drawings are not necessarily to scale, emphasis instead generally being placed upon illustrating the principles of the invention.

FIG. 1 is a block diagram of a system in which unstructured computer text is analyzed and clustered for generation of a structured conversation flow for a conversation service application.

FIG. 2 is a flow diagram of a computerized method for in which unstructured computer text is analyzed for generation of a structured conversation flow for a conversation service application.

FIG. 3 is a workflow diagram of an exemplary transcript preprocessing method performed by question extraction module.

FIG. 4 is a diagram of an exemplary raw transcript prior to pre-processing and an exemplary enriched transcript that results from pre-processing.

FIG. 5 is a detailed block diagram of a combined rule-based and NLP model.

FIG. 6 is a diagram of an exemplary question clustering workflow.

FIG. 7 is a diagram of an exemplary cluster identification label sequencing workflow.

FIG. 8 is a diagram of an exemplary data structure showing association of interaction ID to sequence of cluster identification labels for a plurality of transcripts.

FIG. 9 is a diagram of an exemplary data structure and visualization of a conversation flow graph structure showing association of interaction ID to sequence of cluster identification labels for a plurality of transcripts.

FIG. 10 is a diagram of an exemplary visualization of a conversation flow graph structure.

FIG. 11 is a diagram of an exemplary aggregate conversation flow graph.

### DETAILED DESCRIPTION

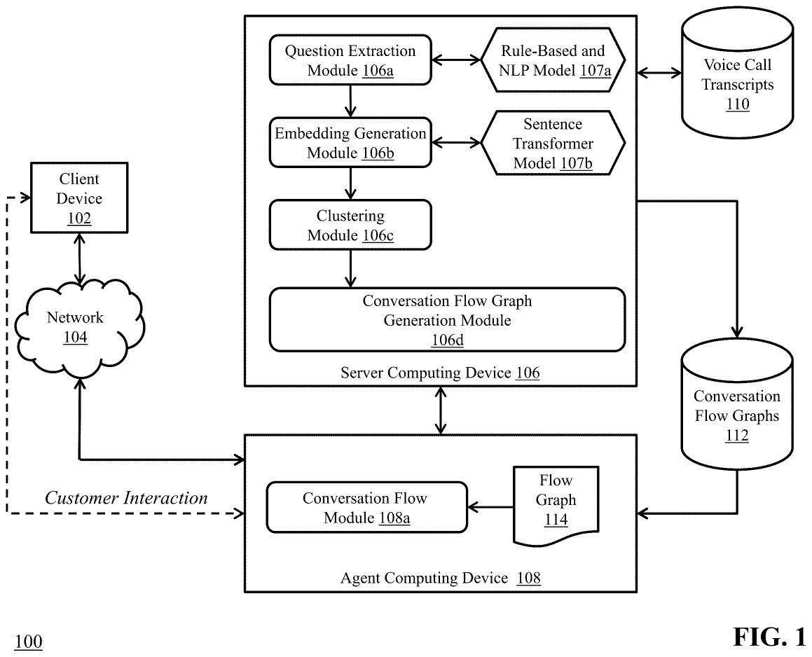

FIG. 1 is a block diagram of system 100 for analysis and clustering of unstructured computer text for generation of a structured conversation flow for a conversation service application. System 100 includes client computing device 102, communications network 104, server computing device 106 that includes question extraction module 106a, embedding generation module 106b, clustering module 106c conversation flow graph generation module 106d, rule-based and natural language processing (NLP) machine learning (ML) model 107a, and sentence transformer ML model 107b. System 100 further includes agent computing device 108 that comprises a conversation flow module 108a and flow graph 114. System 100 further includes voice call transcripts database 110 that includes historical voice call transcript data and conversation flow graphs database 112 that includes conversation flow graphs (e.g., flow graph 114) generated by system 100 as described herein.

Client computing device 102 connects to communications network 104 in order to communicate with agent computing device 106 as part of an automated and/or live conversation session. Exemplary client computing devices 102 include but are not limited to computing devices such as smartphones, tablets, laptops, desktops, smart watches, IP telephony devices, internet appliances, or other devices capable of establishing a user interaction communication session, such as a voice call, with agent computing device 108. It should be appreciated that other types of devices that are capable of connecting to the components of system 100 can be used without departing from the scope of invention.

Agent computing device 108 is a computing device coupled to server computing device 106 (e.g., either directly or via local communication network) and network 104. Agent computing device 108 is used to establish and participate in user interaction communication sessions that originate from client computing device 102. In one example, agent computing device 108 is a workstation (e.g., desktop computer, laptop computer, telephony device) of a customer service agent in a call center that enables the agent to receive voice calls from client device 102, access information and perform actions using software on the agent computing device 108 to provide responses and/or solutions to messages submitted by client device 102. Agent computing device 108 is capable of executing locally stored software applications and also capable of accessing software applications delivered from server computing device 106 (or other computing devices) via a cloud-based or software-as-a-service paradigm. The software applications can provide a wide spectrum of functionality (e.g., CRM, account, sales, inventory, ordering, information access, and the like) to the agent. In some embodiments, agent computing device 108 is a telephony device (e.g., an interactive voice response (IVR) system) that receives a voice call originating from client computing device 102, captures and analyzes spoken utterances from the user of client device 102, determines an appropriate response to the spoken utterances, and generates audio for playback to the user based upon the determined response. In some embodiments, agent computing device 108 is a computing system that includes an interactive conversation service application (e.g., chatbot, virtual assistant) programmed to receive input from a user of client device 102 (such as a text message), interpret the input, and generate output that is responsive to the user input. As can be appreciated, other types of client computing devices that can establish a user interaction communication session with client computing device 102 are within the scope of invention.

As can be appreciated, a user interaction communication session can comprise a conversation between a user at client computing device 102 and either a human agent or an automated system at agent computing device 108. In some embodiments, it is beneficial to structure or arrange the conversation flow so that the agent computing device 108 is configured to ask questions according to a particular sequence, where user responses to the questions can guide agent computing device 108 through the conversation. Conversation flow module 108a of agent computing device 108a tracks and facilitates the conversation flow for a user interaction communication session. In some embodiments, conversation flow module 108a traverses conversation flow graph 114 during the communication session in order to carry out the conversation with the end user. Additional detail about conversation flow graph 114 is provided below.

Communications network 104 enables client computing device 102 to communicate with agent computing device 108. Network 104 is typically a wide area network, such as the Internet and/or a cellular network. In some embodiments, network 104 is comprised of several discrete networks and/or sub-networks (e.g., cellular to Internet, PSTN to Internet, PSTN to cellular, etc.).

Server computing device 106 includes specialized hardware and/or software modules that execute on one or more processors and interact with memory modules of server computing device 106, to receive data from other components of system 100, transmit data to other components of system 100, and perform functions to analyze and cluster unstructured computer text for generation of a structured conversation flow for a conversation service application as described herein. Server computing device 106 includes computing modules 106a-106d that execute on one or more processors of server computing device 106. In some embodiments, modules 106a-106d are specialized sets of computer software instructions programmed onto one or more dedicated processors in server computing device 106 and can include specifically designated memory locations and/or registers for executing the specialized computer software instructions. Server computing device 106 also includes rule-based and NLP model 107a and sentence transformer model 107b, which are machine learning-based models executed by server computing device 106 to perform certain data transformation, analysis, and classification tasks as described herein.

Although computing modules 106a-106d and ML models 107a-107b are shown in FIG. 1 as executing within the same server computing device 106, in some embodiments the functionality of computing modules 106a-106d and ML models 107a-107b can be distributed among a plurality of server computing devices. As shown in FIG. 1, server computing device 106 enables computing modules 106a-106d and ML models 107a-107b to communicate with each other in order to exchange data for the purpose of performing the described functions. It should be appreciated that any number of computing devices, arranged in a variety of architectures, resources, and configurations (e.g., cluster computing, virtual computing, cloud computing) can be used without departing from the scope of the invention. The exemplary functionality of the computing modules 106a-106d and ML models 107a-107b is described in detail below.

Voice call transcripts database 110 is a computing device (or in some embodiments, a set of computing devices) coupled to server computing device 106 and is configured to receive, generate, and store specific segments of data relating to the process of analyzing and clustering unstructured computer text for generation of a structured conversation flow for a conversation service application as described herein. In some embodiments, all or a portion of database 110 can be integrated with server computing device 106 or be located on a separate computing device or devices. Database 110 can comprise one or more databases configured to store portions of data used by the other components of system 100. Database 110 includes historical voice call transcript data which, in some embodiments, is a dedicated section of database 110 that contains specialized data used by the other components of system 100 to perform the analysis and clustering of unstructured computer text for generation of a structured conversation flow as described herein. Further detail on the structure and function of the historical voice call transcript data is provided below.

Conversation flow graphs database 112 is a computing device (or in some embodiments, a set of computing devices) coupled to server computing device 106 and agent computing device 108. Database 112 is configured to receive, generate, and store specific segments of data relating to conversation flow graphs that are generated by server computing device 106 as described herein. Generally, a conversation flow graph comprises a specialized data structure that includes a plurality of nodes connected via edges (also called relationships), where each node corresponds to a question or topic in the overall conversation. A node can include one or more labels to define what kind of node it is. Each edge is assigned a direction for traversal from a source node to a target node, and the edge can include a type to define what type of relationship it is. At least a portion of the nodes and edges in the conversation flow graph can have stored properties (e.g., key-value pairs) which further describe aspects of the node or edge. In some embodiments, each conversation flow graph stored in database 112 corresponds to a historical voice call transcript that has been analyzed and clustered by server computing device 106. A conversation flow graph can be arranged according to a sequence of cluster identification labels generated by server computing device 106 as described herein. In some embodiments, database 112 is a graph database management system (GDBMS) using the Neo4j® platform (available from Neo4j, Inc. of San Mateo, California).

In some embodiments, agent computing device 108 can access conversation flow graphs stored in database 112 in order to modify a conversation flow of a conversation service application (e.g., IVR, chatbot, virtual assistant, guided service application) hosted by agent computing device 108. For example, conversation flow module 108a can retrieve flow graph 114 from database 112 and use the flow graph to: rearrange a sequence of prompts in the conversation flow, add one or more prompts to the conversation flow, remove one or more prompts from the conversation flow, or change content of one or more prompts in the conversation flow.

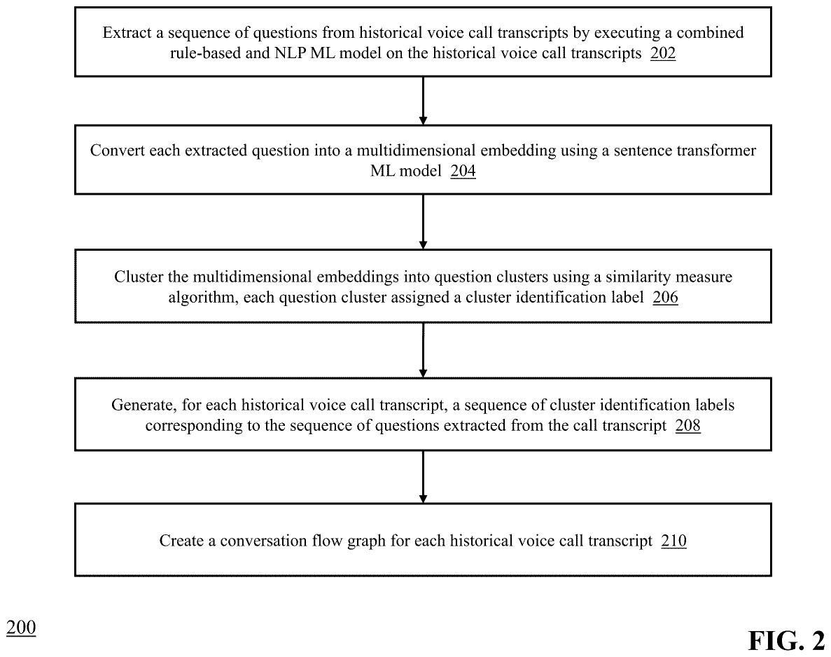

FIG. 2 is a flow diagram of a computerized method 200 for analysis and clustering of unstructured computer text for generation of a structured conversation flow, using system 100 of FIG. 1. Question extraction module 106a extracts (step 202) a sequence of questions from each of a plurality of historical voice call transcripts by executing combined rule-based and NLP machine learning model 107a on the plurality of voice call transcripts. In some embodiments, module 106a retrieves the plurality of historical voice call transcripts from voice call transcripts database 110 for ingestion and processing. As can be appreciated, the historical voice call transcripts correspond to prior voice calls between an agent and a customer—e.g., a customer calls into a customer service agent for assistance with an issue or transaction. Such calls can be recorded, and the audio is converted into unstructured computer text for storage in voice call transcripts database 110. In some embodiments, server computing device 106 captures, e.g., digital bitstreams corresponding to one or more historical voice calls and parses the bitstreams to locate speech segments associated with the agent and/or customer participating in the voice call. It should be appreciated that server computing device 106 can digitize the voice segments, in the case that the segments are captured or otherwise received in non-digital form. Server computing device 106 can also perform functions to improve the audio quality of the digitized voice segments, such as adjusting compression, converting the segments to another format, reducing or eliminating background noise, and so forth. In some embodiments, server computing device 106 can perform the digitization and transcription of historical voice calls using synchronous or asynchronous processing—in one example, as voice call bitstreams are captured, server computing device 106 can digitize and transcribe the calls in real time, whereas in another example, server computing device 106 can periodically digitize and transcribe the calls (e.g., at the end of each day). As an example, the historical voice call transcripts can be stored in database 112 as raw text (.csv) files—although other file types and/or storage formats can be used.

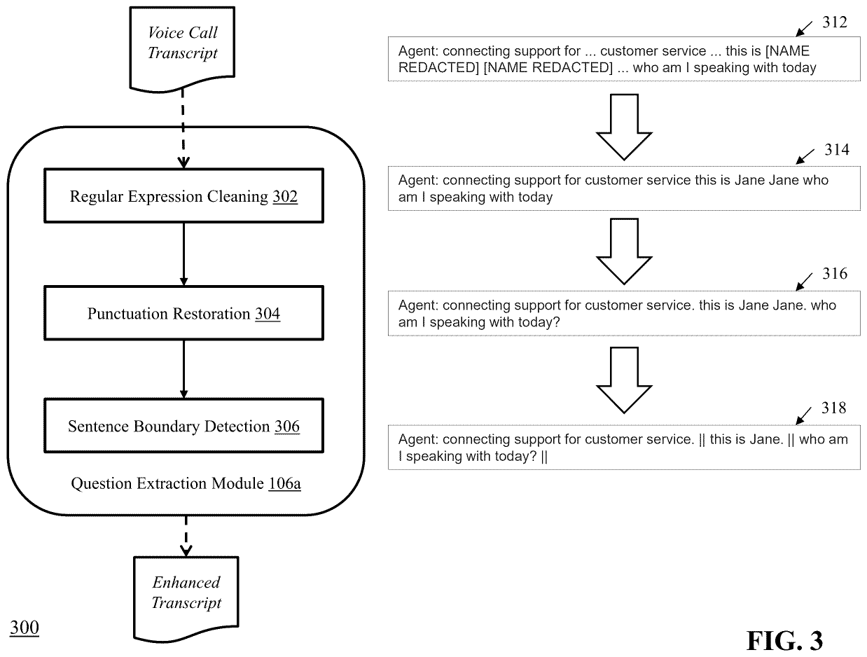

Upon retrieving the plurality of historical voice call transcripts from database 110, question extraction module 106a executes rule-based and NLP machine learning model 107a using the plurality of voice call transcripts as input to extract the questions. In some embodiments, prior to executing model 107a on the plurality of historical voice call transcripts to extract the questions, question extraction module 106a preprocesses the plurality of historical voice call transcripts. FIG. 3 is a workflow diagram of an exemplary transcript preprocessing method 300 performed by question extraction module 106a. As shown in FIG. 3, question extraction module 106a receives a voice call transcript (e.g., from database 112)—in this example, a portion of the raw transcript is shown in area 312. In some embodiments, certain confidential data or personally identifying information (PII) is redacted from the raw transcript before the transcript is stored in database 112 to comply with organizational policies and/or governmental regulations on the storage and retention of such information. In the example of FIG. 3, the customer service agent's first and last names (as spoken on the call) are removed from the raw transcript and replaced with a regular expression (regex), i.e., the string “[NAME REDACTED].” As can be appreciated, model 107a may have difficulty interpreting the transcript to extract questions if regular expressions remain in the text. To avoid potential errors in question extraction during transcript processing, question extraction module 106a performs a regular expression cleaning (step 302) of the raw transcript prior to ingestion by model 107a. Step 302 includes removing the regular expressions in the raw transcript file and inserting default values (also called dummy values) for the corresponding expressions. As shown in area 314 in FIG. 3, the “[NAME REDACTED]” strings have been replaced with the default value “Jane.” In some embodiments, module 106a executes a natural language processing (NLP) model algorithm to conduct the regular expression cleaning step 302. The NLP model algorithm can also perform stopword removal, named entity recognition (NER), and tokenization of the raw transcript in certain embodiments. An exemplary NLP model algorithm for regular expression cleaning used by module 106a is the Natural Language Toolkit (NLTK) Python library, available at nltk.org, and described in Bird, Steven, Edward Loper, and Ewan Klein, Natural Language Processing with Python, O'Reilly Media Inc. (2009).

As the next step, question extraction module 106a performs punctuation restoration (step 304) on the transcript to insert and/or correct punctuation in the text corpus. In the example of FIG. 3, after regular expression cleaning, the transcript text does not have any punctuation (see area 314). Module 106a can provide the transcript text as input to a large language model (LLM) algorithm to analyze the text and determine appropriate punctuation to be inserted. As shown in area 316 of FIG. 3, two periods (′.′) and a question mark (′?′) have been inserted at certain points in the text corpus. In some embodiments, module 106a can connect to an external computing device that hosts a punctuation detection LLM algorithm (e.g., via API) and provide the corresponding input for processing. In other embodiments, module 106a executes an LLM algorithm on one or more processors of server computing device 106 to perform the punctuation restoration. An exemplary punctuation restoration LLM algorithm used by module 106a is SJ-Ray/Re-Punctuate, a text-to-text Transfer Transformer (T5) model, available from huggingface.co/SJ-Ray/Re-Punctuate.

After punctuation restoration step, question extraction module 106a performs sentence boundary detection (step 306) on the punctuated transcript. Module 106a can provide the punctuated transcript text as input to a large language model (LLM) algorithm to analyze the text and determine sentence boundaries. In the example of FIG. 3, the character string (′∥′) is included in the text corpus to denote the boundary of each sentence (see area 318)—although it should be appreciated that this is merely illustrative and, in some embodiments, module 106a does not insert any additional characters in the text corpus when detecting sentence boundaries. In some embodiments, module 106a can connect to an external computing device that hosts a sentence boundary LLM algorithm (e.g., via API) and provide the corresponding input for processing. In other embodiments, module 106a executes an LLM algorithm on one or more processors of server computing device 106 to perform the sentence boundary detection. An exemplary sentence boundary detection LLM algorithm used by module 106a is SJ-Ray/Re-Punctuate (as described above). In some embodiments, module 106a performs both punctuation restoration and sentence boundary detection using a single process/algorithm.

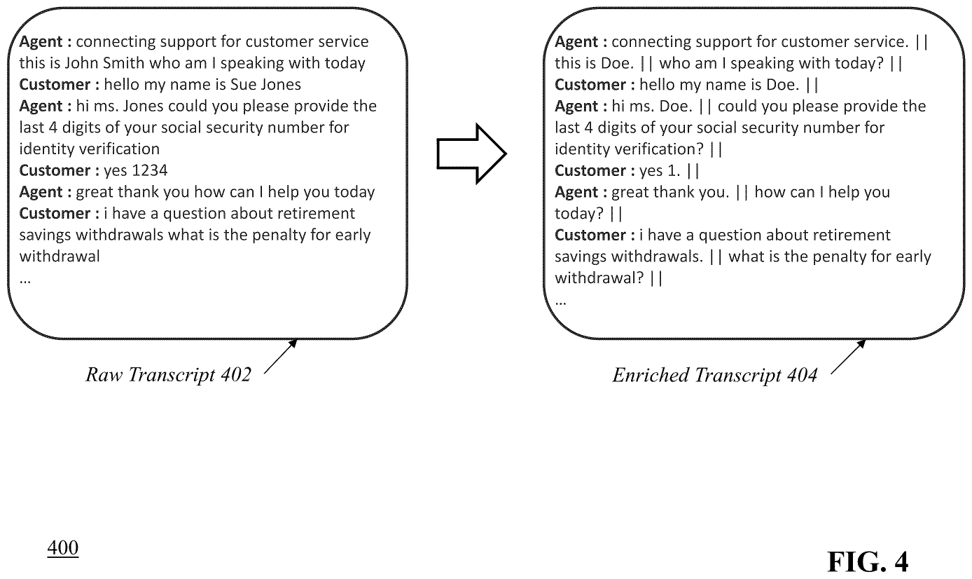

The result of steps 302-306 is an enriched voice call transcript. FIG. 4 is a diagram of an exemplary raw transcript 402 (i.e., retrieved from database 110) prior to pre-processing by question extraction module 106a and an exemplary enriched transcript 404 that results from the pre-processing of module 106a.

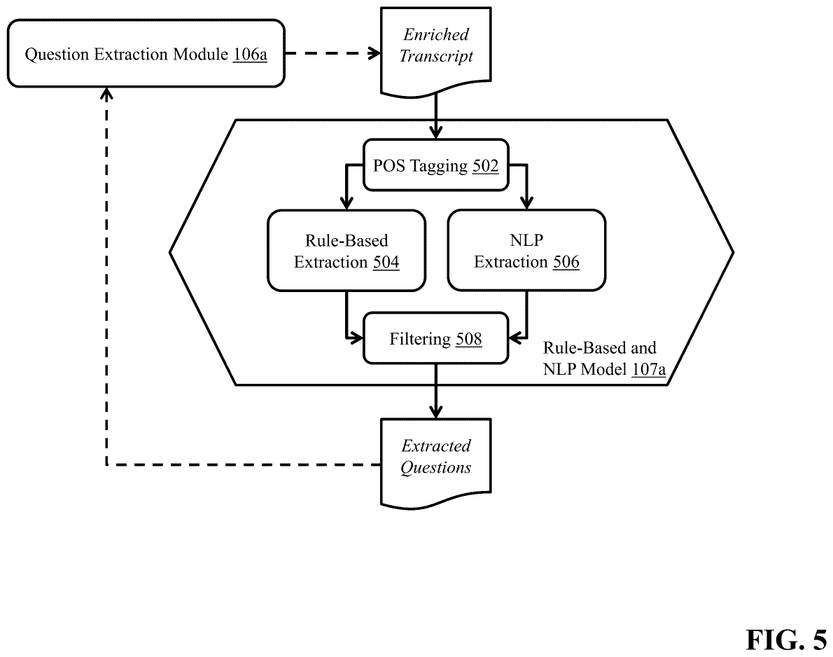

The enriched voice call transcript generated by module 106a is provided as input to combined rule-based and NLP model 107a for extraction of questions from the transcript. FIG. 5 is a detailed block diagram of combined rule-based and NLP model 107a. As shown in FIG. 5, model 107a comprises a plurality of processing functions: part-of-speech (POS) tagging function 502, rule-based extraction function 504, NLP extraction function 506, and filtering function 508. Function 502 receives the enriched transcript from question extraction module 106a and performs POS tagging on the transcript. Then, functions 504 and 506 process the tagged transcript to detect and extract questions. Finally, function 508 generates a filtered list of extracted questions for transmission back to question extraction module 106a.

Generally, POS tagging comprises detecting the part of speech for each word in the transcript and assigning a tag/token to each word where the tag/token corresponds to the detected part of speech of the word. As an example, the sentence “I have a question about my account.” can be POS tagged by function 502 as follows:

| Word | POS Tag |
|---|---|
| I | PRN (pronoun) |
| have | VERB |
| a | DET (determiner) |
| question | NOUN |
| regarding | ADP (adposition) |
| my | PRN |
| account | NOUN |
| . | PUNCT (punctuation) |

As shown in FIG. 5, POS tagging function 502 provides the tagged transcript to each of rule-based extraction function 504 and NLP extraction function 506. It can be appreciated, however, that the processing performed by functions 504 and 506 can be performed sequentially (e.g., the output of one function 504, 506 can be provided to the other function) and/or in parallel.

Rule-based extraction function 504 analyzes the tagged words in each sentence using one or more pre-configured rules to determine whether the sentence is a question. Using the English language as an example, questions are generally formed using a “wh-” word (e.g., who, what, when, where, and why) in conjunction with an auxiliary verb (e.g., be, do, and have). Based upon this concept, function 502 can be configured with a rule that identifies any sentence that contains (or starts with) a “wh-” word plus an auxiliary verb as a question. For example, function 502 can identify the sentence “what is my account balance?” as a question because the sentence contains the word “what” plus the verb “is.” It should be appreciated that the above rule is merely an example, and other preconfigured rules can be provided to function 502 for use in identifying questions in the tagged transcript.

NLP extraction function 506 analyzes the tagged transcript using one or more NLP techniques—such as semantic parsing or dependency parsing—to determine the structure of sentences. By analyzing the structure and relationship between words, function 506 can detect which sentences are questions. In some embodiments, NLP extraction function 504 executes an NLP model algorithm using the tagged transcript to perform the semantic parsing and/or dependency parsing. An exemplary NLP model algorithm for semantic parsing and/or dependency parsing used by function 504 is the Natural Language Toolkit (NLTK) Python library, supra.

Filtering function 508 receives the lists of extracted questions from functions 504 and 506, determines whether any of the questions should be removed from the lists, and generates a final list of extracted questions for transmission to module 106a. As can be appreciated, there may be situations where functions 504 and 506 extract the same question from the tagged transcript. Instead of including duplicates of the question in the final list, filtering function 508 can merge the lists together into a list of unique questions. For example, filtering function 508 can utilize a string matching algorithm to compare each question in the list generated by function 504 with each question in the list generated by function 506 to determine whether the questions match. In some embodiments, filtering function 508 can calculate a degree of similarity between the questions in each list (e.g., distance measure), and use the degree of similarity to determine whether questions are duplicative.

Turning back to FIG. 2, question extraction module 106a provides the extracted questions to embedding generation module 106b, which converts (step 204) each extracted question into a multidimensional embedding. Module 106b utilizes sentence transformer model 107b to generate the embeddings for each sentence. In some embodiments, embedding generation module 106b executes sentence transformer model 107b using the list of questions as input to generate the multidimensional embeddings. An exemplary sentence transformer model 107b is the sentence-transformers/all-MiniLM-L6-v2 model, available at huggingface.co/sentence-transformers/all-MiniLM-L6-v2. This model is constructed using the Sentence Transformers (SBERT) Python module (sbert.net)—which is configured to map each question in the list of questions to a 384-dimension dense vector space. In an example, sentence transformer model 107b converts each question string into a numerical vector representation (e.g., [0.1, 0.37, 0.55, . . . , 0.92]) where the values encode meaningful semantic information of the sentence and can be compared to vectors from other sentences to determine similarity. Further information regarding the SBERT model architecture is described in Reimers, N. and I. Gurevych, “Sentence-BERT: Sentence Embeddings using Siamese BERT-Networks,” arXiv:1908.10084v1 [cs.CL], Aug. 27, 2019, available at arxiv.org/pdf/1908.10084.pdf, which is incorporated herein by reference.

Embedding generation module 106b transmits the generated embeddings for each of the extracted questions to clustering module 106c. Module 106c clusters (step 206) the multidimensional embeddings into question clusters using a similarity measure algorithm and each question cluster is assigned a cluster identification label. Generally, clustering is a technique where similar data points are grouped together into clusters based on patterns or features in the data points. In this example, the multidimensional embeddings generated from the questions are clustered together based upon similarity between the respective embeddings.

In some embodiments, clustering module 106c reduces the dimensionality of the question embeddings before performing the clustering step. As mentioned above, the question embeddings created by embedding generation module 106b may comprise a large number of dimensions (e.g., 384 dimensions or more). The corresponding clustering algorithm used by clustering module 106c may be unable to cluster embeddings effectively above a certain dimension size or the clustering algorithm may require significant processing power and/or time to complete the clustering. Therefore, in some embodiments, reducing the number of dimensions of the embeddings can improve performance of the clustering algorithm by reducing the amount of time and/or processing power needed to perform clustering. Clustering module 106c can perform a dimensionality reduction technique on the input embeddings prior to clustering. One example of a dimensionality reduction technique that can be employed by module 106c is Uniform Manifold at Approximation and Projection (UMAP), available github.com/lmcinnes/umap and described at umap-learn.readthedocs.io/en/latest/. Further information about the operation of UMAP is described in McInnes, L. et al., “UMAP: Uniform Manifold Approximation and Projection for Dimension Reduction,” arXiv:1802.03426v3 [stat.ML], Sep. 18, 2020, available at arxiv.org/pdf/1802.03426, which is incorporated herein by reference. It should be appreciated that other types of dimensionality reduction algorithms or techniques (e.g., principal component analysis (PCA), linear discriminant analysis (LDA)) can be used with clustering module 106c.

As mentioned above, clustering module 106c clusters the embeddings using a similarity measure algorithm which compares features of the respective embeddings and groups embeddings with similar features into clusters. Clustering module 106c can use one of several different similarity measure algorithms, including but not limited to: (i) Hierarchical Density-based Spatial Clustering of Applications with Noise (HDBSCAN) (as described in Campello, R. et al., “Density-Based Clustering Based on Hierarchical Density Estimates,” Advances in Knowledge Discovery and Data Mining (PAKDD 2013), Lecture Notes in Computer Science, vol. 7819, pp. 160-172 (2013), which is incorporated herein by reference) or (ii) k-means clustering, which is an iterative, centroid-based clustering algorithm. It should be appreciated that other types of clustering algorithms or techniques can be used with clustering module 106c.

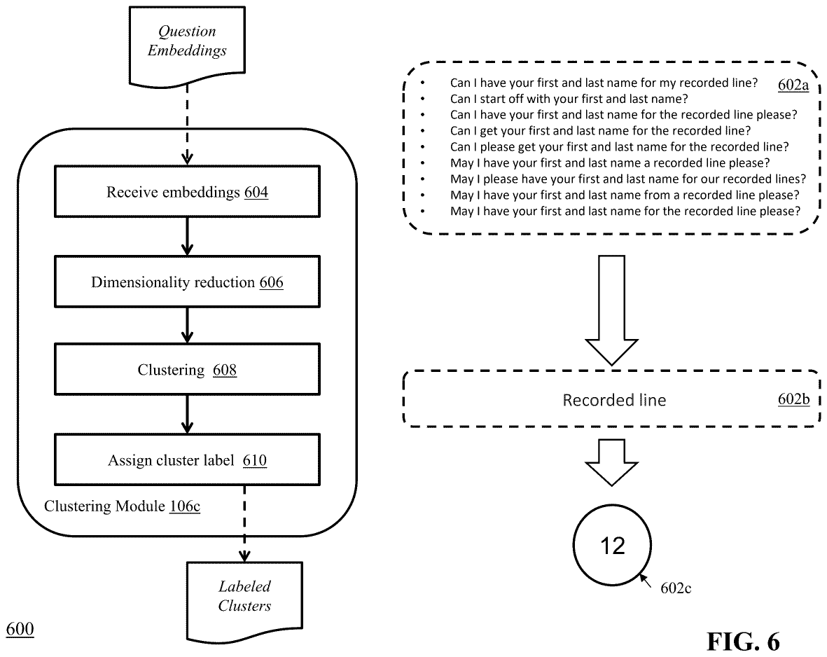

FIG. 6 is a diagram of an exemplary clustering workflow as performed by clustering module 106c. A sample of similar questions extracted from the voice call transcripts using question extraction module 106a and combined are shown in area 602 for reference. Clustering module 106c receives (step 604) the multidimensional embeddings, performs (step 606) dimensionality reduction on the embeddings, and clusters (step 608) the embeddings. As shown in FIG. 6, the cluster 602b (‘recorded line’) is generated and contains the embeddings for the questions 602a identified above. Module 106c then assigns (step 610) a cluster identification label 602c to each cluster. In some embodiments, the cluster identification label 602c is a numeric value and/or alphanumeric value that uniquely identifies the cluster.

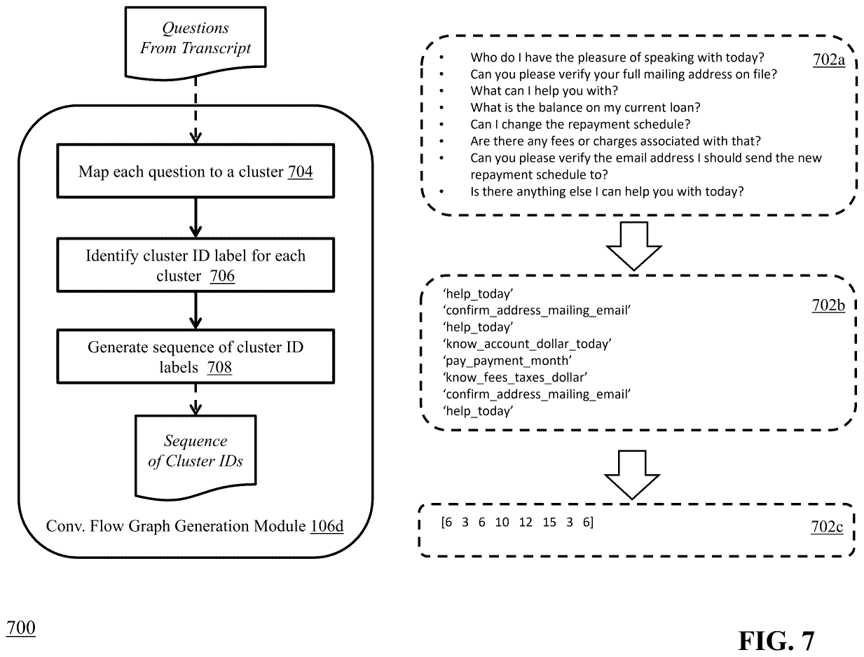

Turning back to FIG. 2, conversation flow graph generation module 106d uses the generated clusters and corresponding identification labels to generate (step 208) for each historical voice call transcript, a sequence of cluster identification labels corresponding to the sequence of questions extracted from the call transcript. FIG. 7 is a diagram of an exemplary cluster identification label sequencing workflow 700 as performed by module 106d. In some embodiments, module 106d receives the extracted questions from a particular voice call transcript (as generated by module 106a). Exemplary questions from a transcript are provided in area 702a. Conversation flow graph generation module 106d maps (step 704) each question to a corresponding cluster (as generated by module 106c). The cluster mappings for the example questions are provided in area 702b. Module 106d identifies (step 706) the cluster identification label for each mapped cluster and generates (step 708) a sequence of the cluster identification labels that corresponds to the original sequence of extracted questions. The sequence of cluster identification labels for the mapped clusters is provided in area 702c.

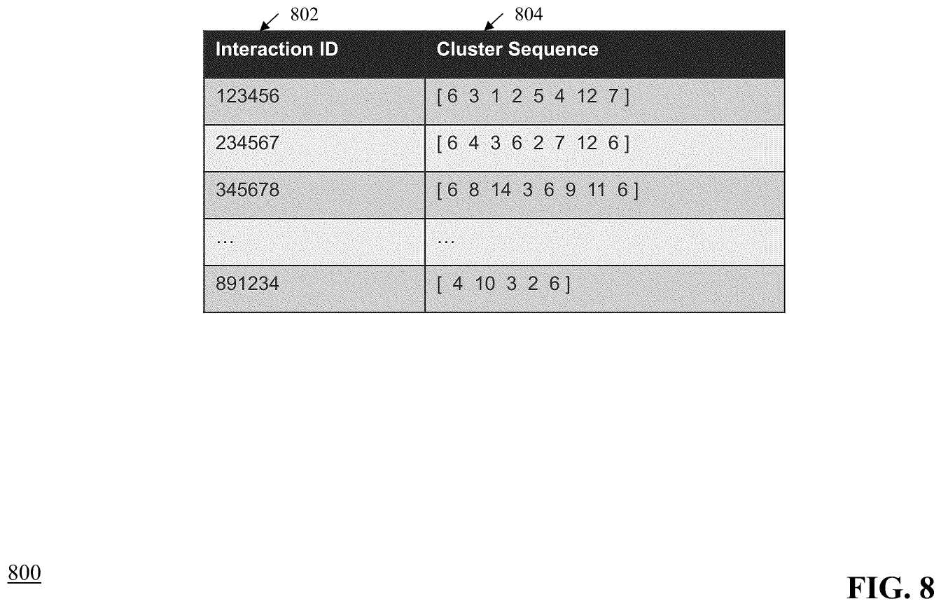

In some embodiments, conversation flow graph generation module 106d stores the sequence of cluster identification labels in, e.g., voice call transcripts database 110 and/or conversation flow graphs database 112. Module 106d can associate the sequence of cluster identification labels with the corresponding transcript in a data structure that is stored in database(s) 110 and/or 112. For example, each transcript can be assigned an interaction ID at the time the transcript is created. The interaction ID uniquely identifies the transcript and the sequence of cluster identification labels can be mapped to the interaction ID. FIG. 8 is a diagram of an exemplary data structure 800 showing the association of interaction ID (column 802) to sequence of cluster identification labels (column 804) for a plurality of transcripts. In some embodiments, module 106d is configured to convert the mapping of interaction IDs and sequences of cluster identification labels to a comma-separated value (.csv) file. This enables module 106d to generate a conversation flow graph for the transcript as described below.

Turning back to FIG. 2, conversation flow graph generation module 106d utilizes the sequences of cluster identification labels and associated questions to create (step 210) a conversation flow graph for one or more of the historical voice call transcripts. In some embodiments, module 106d performs triplet extraction on the input data to prepare the data for loading into database 112 (i.e., graph database management system such as Neo4j®). Database 112 can be located in a cloud computing environment (such as Amazon® AWS™) and module 106d can upload the data as a dataframe to a storage container in the cloud computing environment (e.g., S3 storage in AWS) for generation of the conversation flow graph. In some embodiments, module 106d uses the triplet extraction process to get source and target nodes for building the conversation graph. For example, a voice call may comprise a conversation that contains the sequence of question clusters as [2, 4, 10, 5, 9, 12]. In this example, the first question in the voice call is from cluster 2, the next question during the call is from cluster 4, and so on. To build the conversation graph, module 106d identifies a source node (in this case, the node representing cluster 2 is the source node) and identifies a target node (i.e., the node representing cluster 4 is the target node) at level 1. In a different level (level 2), the node representing cluster 4 is the source node and the node representing cluster 10 is the target node. Module 106d repeats the source and target node identification process to cover the full sequence of question clusters. In this example, module 106d is counting the number of occurrence(s) of the same question cluster pattern, so a node property called freq comprises the count of the occurrence(s) for the same sequence. As a result, module 106d extracts a triplet as [Source, Count, Target]. In some embodiments, the triplets are captured in S3 dataframe(s).

Conversation flow graph generation module 106d then generates the conversation flow graph for the transcript by creating nodes and relationships using the uploaded data. Generally, each node in the conversation flow graph corresponds to a cluster identification label in the sequence of labels and the nodes are connected by relationships according to the defined sequence. In some embodiments, module 106d can use the following exemplary programmatic commands to create the relationships between nodes:
match (x: Cluster)
match (y: Cluster)
where y.parent=x.cluster and y.parent_ancestor=x.ancestors
merge (x)-[r: NEXT]→(y)

Once the nodes and relationships for the graph are defined, module 106d adds a ‘start’ node (or root node) to the graph using the following exemplary programmatic commands:
match (n: Cluster) where not (n)←[: NEXT]-( )
merge (k: S_node {name: “starting”})
merge (k)-[: NEXT]→(n)

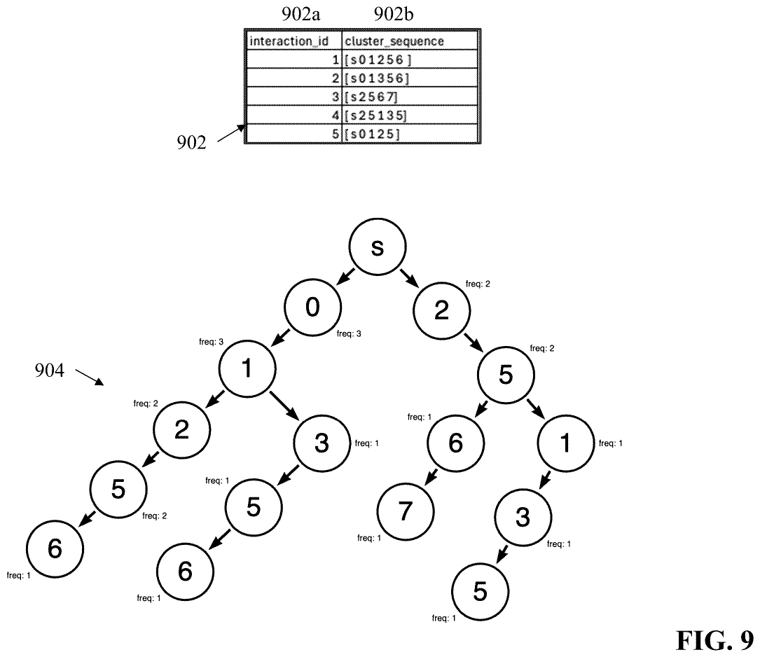

FIG. 9 is a diagram of an exemplary data structure 902 and visualization of the corresponding conversation flow graph data structure 904 showing the association of interaction ID (column 902a) to sequence of cluster identification labels (column 902b) for a plurality of transcripts. As shown in FIG. 9, data structure 902 includes a plurality of interaction IDs each mapped to a cluster sequence—where the cluster sequence is an ordered list of clusters starting with a root node ‘s.’ As can be appreciated, the cluster sequence enables traversal of the corresponding graph structure 904 according to the ordered list, which represents a particular conversation flow for the conversation service application. Each node in the graph 904 is associated with a frequency value (freq).

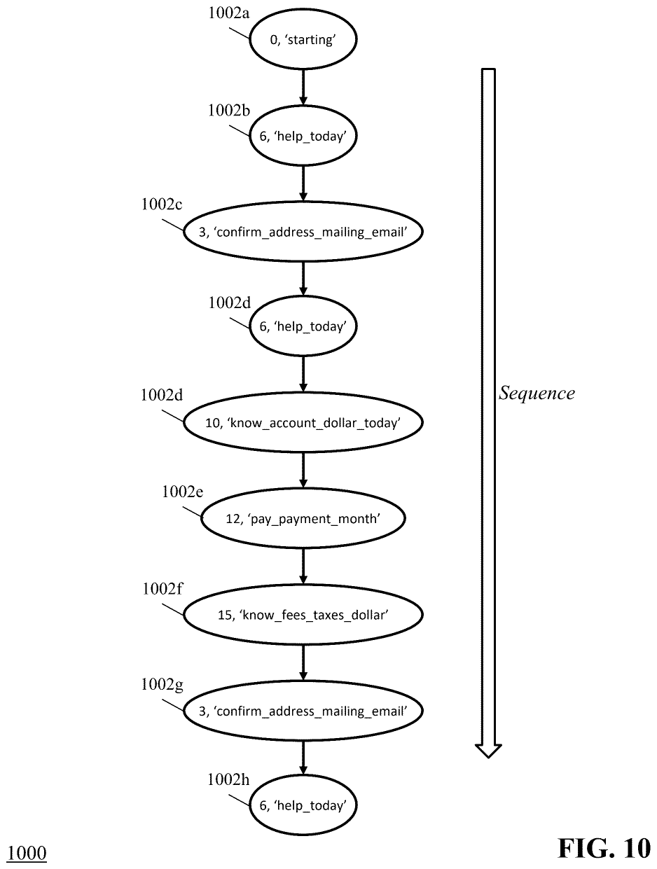

FIG. 10 is a diagram of an exemplary visualization of a conversation flow graph structure 1000 created by conversation flow graph generation module 106d. As shown in FIG. 10, graph 1000 comprises a plurality of nodes 1002a-1002h, each assigned the cluster identification label and cluster name to which the associated question is assigned (e.g., 3, ‘confirm_address_mailing_email’). As can be appreciated, the sequence of nodes corresponds to the sequence of labels/questions from the transcript.

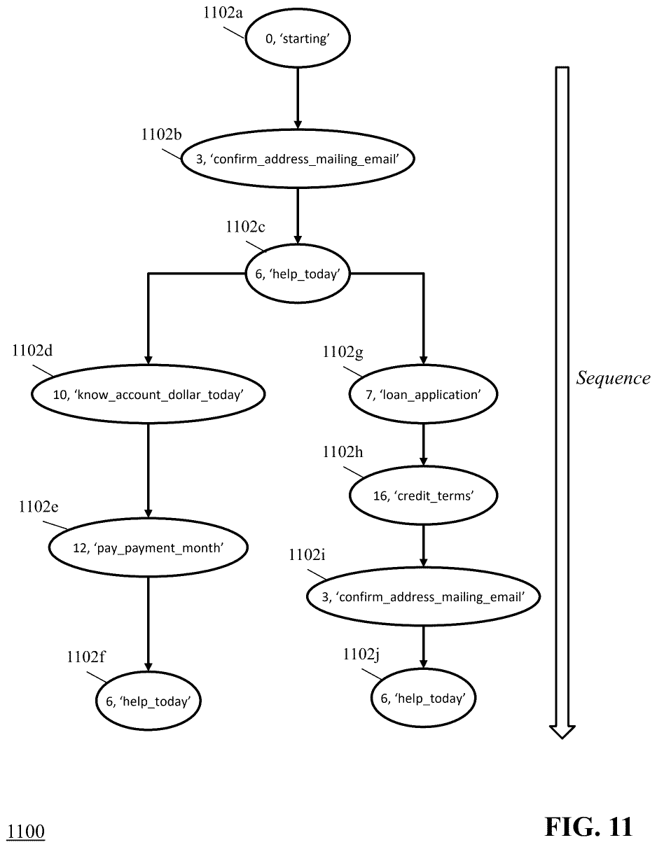

Once the conversation flow graphs have been generated, system 100 can beneficially use the conversation flow graphs to modify existing or planned conversation flows of conversation service applications (e.g., IVR, chatbot, virtual assistant) in order to provide an improved conversation flow and experience for the end user. In some embodiments, system 100 is configured to merge at least two of the conversation flow graphs to generate an aggregate conversation flow graph that is used to modify the conversation service applications. For example, two conversation flow graphs may begin with the same sequence of questions/cluster identification labels and then diverge to different clusters as more questions were presented during the voice call. System 100 can generate an aggregate conversation flow graph that contains separate branches where the conversation flow graphs diverge and common branches where the conversation flow graphs are the same. FIG. 11 is a diagram of an exemplary aggregate conversation flow graph 1100. As shown in FIG. 11, the conversation flow graph 1100 includes nodes 1102a-1102c which represent a common branch between conversation flow graphs of two or more different voice call transcripts-meaning that each voice call transcript reflects the same question clusters in the same sequence. After node 1102c, the graph 1100 diverges into two separate branches: the first branch comprising nodes 1102d, 1102e, and 1102f, and the second branch comprising nodes 1102g, 1102h, 1102i, and 1102j. This means that the questions presented during the voice call transcripts for a first set of calls after node 1102c were different from the questions presented during a second set of calls.

System 100 can compare one or more of the aggregate conversation flow graphs to an existing conversation flow for the conversation service application and determine whether to modify the existing conversation flow based upon the aggregate graph. For example, the historical voice call transcripts may reflect that customers and agents typically exchange utterances that define a certain sequence of question clusters, whereas the existing conversation flow for a conversation service application includes a sequence of questions/intents that differs from the historical voice calls. In some embodiments, it can be determined that the outcome associated with the historical voice call transcripts (e.g., user satisfaction, user engagement, return on investment, etc.) is better than the outcome associated with corresponding conversation service application conversations. Therefore, system 100 can modify the conversation flow for the conversation service application to conform to the conversation flow represented in the flow graph generated from the historical voice call transcripts.

In some embodiments, system 100 can modify the conversation flow of a conversation service application by rearranging a sequence of prompts in the conversation flow. For example, the historical voice call transcripts can reflect that customers typically request their account balance before initiating a percentage change transaction for their retirement savings contributions. However, the sequence of prompts for a chatbot application may initiate the percentage change transaction first and then inquire whether the end user would like to see their account balance. Based upon the conversation flow graph, system 100 can modify the chatbot prompts so that the account balance prompt is placed before the percentage change transaction prompt. Similarly, system 100 can add or remove one or more prompts to the conversation flow of the chatbot—e.g., if the chatbot does not inquire whether the user would like to see their account balance, system 100 can insert a new prompt into the chatbot's conversation flow to match the sequence discovered from the voice call transcripts.

System 100 can also change content of one or more prompts in a conversation flow of the conversation service application. As an example, system 100 can determine that the text of a particular prompt in the conversation service application is constructed differently from the text of a same or similar question that is typically asked by an agent during the historical voice calls. For example, the agent may ask questions that are included in a question list that has been approved according to organizational or regulatory requirements. System 100 can update the prompt text of the conversation service application to more accurately conform to the question text so that users of the conversation service application have the same experience as customers participating in voice calls.

The above-described techniques can be implemented in digital and/or analog electronic circuitry, or in computer hardware, firmware, software, or in combinations of them. The implementation can be as a computer program product, i.e., a computer program tangibly embodied in a machine-readable storage device, for execution by, or to control the operation of, a data processing apparatus, e.g., a programmable processor, a computer, and/or multiple computers. A computer program can be written in any form of computer or programming language, including source code, compiled code, interpreted code and/or machine code, and the computer program can be deployed in any form, including as a stand-alone program or as a subroutine, element, or other unit suitable for use in a computing environment. A computer program can be deployed to be executed on one computer or on multiple computers at one or more sites.

The computer program can be deployed in a cloud computing environment (e.g., Amazon® AWS, Microsoft® Azure, IBM® Cloud™). A cloud computing environment includes a collection of computing resources provided as a service to one or more remote computing devices that connect to the cloud computing environment via a service account—allowing access to the computing resources. Cloud applications use various resources that are distributed within the cloud computing environment, across availability zones, and/or across multiple computing environments or data centers. Cloud applications are hosted as a service and use transitory, temporary, and/or persistent storage to store their data. These applications leverage cloud infrastructure that eliminates the need for continuous monitoring of computing infrastructure by the application developers, such as provisioning servers, clusters, virtual machines, storage devices, and/or network resources. Instead, developers use resources in the cloud computing environment to build and run the application and store relevant data.

Method steps can be performed by one or more processors executing a computer program to perform functions of the invention by operating on input data and/or generating output data. Subroutines can refer to portions of the stored computer program and/or the processor, and/or the special circuitry that implement one or more functions. Processors suitable for the execution of a computer program include, by way of example, special purpose microprocessors specifically programmed with instructions executable to perform the methods described herein, and any one or more processors of any kind of digital or analog computer. Generally, a processor receives instructions and data from a read-only memory or a random-access memory or both. The essential elements of a computer are a processor for executing instructions and one or more memory devices for storing instructions and/or data. Exemplary processors can include, but are not limited to, integrated circuit (IC) microprocessors (including single-core and multi-core processors). Method steps can also be performed by, and an apparatus can be implemented as, special purpose logic circuitry, e.g., a FPGA (field programmable gate array), a FPAA (field-programmable analog array), a CPLD (complex programmable logic device), a PSoC (Programmable System-on-Chip), ASIP (application-specific instruction-set processor), an ASIC (application-specific integrated circuit), Graphics Processing Unit (GPU) hardware (integrated and/or discrete), another type of specialized processor or processors configured to carry out the method steps, or the like.

Memory devices, such as a cache, can be used to temporarily store data. Memory devices can also be used for long-term data storage. Generally, a computer also includes, or is operatively coupled to receive data from or transfer data to, or both, one or more mass storage devices for storing data, e.g., magnetic, magneto-optical disks, or optical disks. A computer can also be operatively coupled to a communications network in order to receive instructions and/or data from the network and/or to transfer instructions and/or data to the network. Computer-readable storage mediums suitable for embodying computer program instructions and data include all forms of volatile and non-volatile memory, including by way of example semiconductor memory devices, e.g., DRAM, SRAM, EPROM, EEPROM, and flash memory devices (e.g., NAND flash memory, solid state drives (SSD)); magnetic disks, e.g., internal hard disks or removable disks; magneto-optical disks; and optical disks, e.g., CD, DVD, HD-DVD, and Blu-ray disks. The processor and the memory can be supplemented by and/or incorporated in special purpose logic circuitry.

To provide for interaction with a user, the above-described techniques can be implemented on a computing device in communication with a display device, e.g., a CRT (cathode ray tube), plasma, or LCD (liquid crystal display) monitor, a mobile device display or screen, a holographic device and/or projector, for displaying information to the user and a keyboard and a pointing device, e.g., a mouse, a trackball, a touchpad, or a motion sensor, by which the user can provide input to the computer (e.g., interact with a user interface element). The systems and methods described herein can be configured to interact with a user via wearable computing devices, such as an augmented reality (AR) appliance, a virtual reality (VR) appliance, a mixed reality (MR) appliance, or another type of device. Exemplary wearable computing devices can include, but are not limited to, headsets such as Meta™ Quest 3™ and Apple® Vision Pro™. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, and/or tactile input.

The above-described techniques can be implemented in a distributed computing system that includes a back-end component. The back-end component can, for example, be a data server, a middleware component, and/or an application server. The above-described techniques can be implemented in a distributed computing system that includes a front-end component. The front-end component can, for example, be a client computer having a graphical user interface, a Web browser through which a user can interact with an example implementation, and/or other graphical user interfaces for a transmitting device. The above-described techniques can be implemented in a distributed computing system that includes any combination of such back-end, middleware, or front-end components.

The components of the computing system can be interconnected by transmission medium, which can include any form or medium of digital or analog data communication (e.g., a communication network). Transmission medium can include one or more packet-based networks and/or one or more circuit-based networks in any configuration. Packet-based networks can include, for example, the Internet, a carrier internet protocol (IP) network (e.g., local area network (LAN), wide area network (WAN),), a private IP network, an IP private branch exchange (IPBX), a wireless network (e.g., radio access network (RAN), Bluetooth™, near field communications (NFC) network, Wi-Fi™, WiMAX™, general packet radio service (GPRS) network, HiperLAN), and/or other packet-based networks. Circuit-based networks can include, for example, the public switched telephone network (PSTN), a legacy private branch exchange (PBX), a wireless network (e.g., RAN, code-division multiple access (CDMA) network, time division multiple access (TDMA) network, global system for mobile communications (GSM) network), cellular networks, and/or other circuit-based networks.

Information transfer over transmission medium can be based on one or more communication protocols. Communication protocols can include, for example, Ethernet protocol, Internet Protocol (IP), Voice over IP (VOIP), a Peer-to-Peer (P2P) protocol, Hypertext Transfer Protocol (HTTP), Session Initiation Protocol (SIP), H.323, Media Gateway Control Protocol (MGCP), Signaling System #7 (SS7), a Global System for Mobile Communications (GSM) protocol, a Push-to-Talk (PTT) protocol, a PTT over Cellular (POC) protocol, Universal Mobile Telecommunications System (UMTS), 3GPP Long Term Evolution (LTE), cellular (e.g., 4G, 5G), and/or other communication protocols.

Devices of the computing system can include, for example, a computer, a computer with a browser device, a telephone, an IP phone, a mobile device (e.g., cellular phone, personal digital assistant (PDA) device, smartphone, tablet, laptop computer, electronic mail device), and/or other communication devices. The browser device includes, for example, a computer (e.g., desktop computer and/or laptop computer) with a World Wide Web browser (e.g., Chrome™ from Google, Inc., Safari™ from Apple, Inc., Microsoft® Edge® from Microsoft Corporation, and/or Mozilla® Firefox from Mozilla Corporation). Mobile computing devices include, for example, an iPhone® from Apple Corporation, and/or an Android™-based device. IP phones include, for example, a Cisco® Unified IP Phone 7985G and/or a Cisco® Unified Wireless Phone 7920 available from Cisco Systems, Inc.

The methods and systems described herein can utilize artificial intelligence (AI) and/or machine learning (ML) algorithms to process data and/or control computing devices. In one example, a classification model, is a trained ML algorithm that receives and analyzes input to generate corresponding output, most often a classification and/or label of the input according to a particular framework.

Comprise, include, and/or plural forms of each are open ended and include the listed parts and can include additional parts that are not listed. And/or is open ended and includes one or more of the listed parts and combinations of the listed parts.

One skilled in the art will realize the subject matter may be embodied in other specific forms without departing from the spirit or essential characteristics thereof. The foregoing embodiments are therefore to be considered in all respects illustrative rather than limiting of the subject matter described herein.

What is claimed is:

1. A system used in a computing environment in which unstructured computer text is analyzed for generation of a structured conversation flow for a conversation service application, the system comprising a server computing device having a memory for storing computer-executable instructions and a processor that executes the computer-executable instructions to:
extract a sequence of questions from each of a plurality of historical voice call transcripts by executing, using the processor, a combined rule-based and natural language processing machine learning model on the plurality of historical voice call transcripts;
convert each of the extracted questions into a multidimensional embedding using a sentence transformer machine learning model;
cluster the multidimensional embeddings into one or more question clusters using a similarity measure algorithm, each of the question clusters assigned a cluster identification label;
generate, for each historical voice call transcript, a sequence of cluster identification labels corresponding to the sequence of questions extracted from the call transcript; and
create a conversation flow graph for each historical voice call transcript based upon the associated sequence of cluster identification labels.

2. The system of claim 1, wherein the server computing device modifies a conversation flow of the conversation service application using the conversation flow graph.

3. The system of claim 2, wherein modifying a conversation flow of the conversation service application comprises rearranging a sequence of prompts in a conversation flow of the conversation service application, adding one or more prompts to a conversation flow of the conversation service application, removing one or more prompts from a conversation flow of the conversation service application, or changing content of one or more prompts in a conversation flow of the conversation service application.

4. The system of claim 3, wherein the conversation service application comprises a chatbot application, an interactive voice response (IVR) application, a virtual assistant application, or a guided service application.

5. The system of claim 1, wherein the server computing device preprocesses the plurality of historical voice call transcripts before executing the combined rule-based and natural language processing machine learning model on the plurality of historical voice call transcripts.

6. The system of claim 5, wherein preprocessing the plurality of historical voice call transcripts comprises:
replacing one or more regular expressions in the historical voice call transcripts with default values;
detecting boundaries between sentences in the historical voice call transcripts; and
inserting punctuation at each sentence boundary in the historical voice call transcripts.

7. The system of claim 6, wherein the server computing device executes a natural language processing model to replace the regular expressions and the server computing device executes a large language model to detect the boundaries and insert the punctuation.

8. The system of claim 1, wherein the similarity measure algorithm comprises a k-means clustering algorithm or an hdbscan algorithm.

9. The system of claim 1, wherein the conversation flow graph comprises a data structure with a plurality of nodes connected via edges and arranged according to the sequence of cluster identification labels.

10. The system of claim 1, wherein the server computing device merges at least two of the conversation flow graphs to generate an aggregate conversation flow graph.

11. A computerized method in which unstructured computer text is analyzed for generation of a structured conversation flow for a conversation service application, the method comprising:
extracting, by a server computing device, a sequence of questions from each of a plurality of historical voice call transcripts by executing, using the processor, a combined rule-based and natural language processing machine learning model on the plurality of historical voice call transcripts;
converting, by the server computing device, each of the extracted questions into a multidimensional embedding using a sentence transformer machine learning model;
clustering, by the server computing device, the multidimensional embeddings into one or more question clusters using a similarity measure algorithm, each of the question clusters assigned a cluster identification label;
generating, by the server computing device for each historical voice call transcript, a sequence of cluster identification labels corresponding to the sequence of questions extracted from the call transcript; and
creating, by the server computing device, a conversation flow graph for each historical voice call transcript based upon the associated sequence of cluster identification labels.

12. The method of claim 11, further comprising modifying, by the server computing device, a conversation flow of the conversation service application using the conversation flow graph.

13. The method of claim 12, wherein modifying the conversation flow of the conversation service application comprises rearranging a sequence of prompts in a conversation flow of the conversation service application, adding one or more prompts to a conversation flow of the conversation service application, removing one or more prompts from a conversation flow of the conversation service application, or changing content of one or more prompts in a conversation flow of the conversation service application.

14. The method of claim 13, wherein the conversation service application comprises a chatbot application, an interactive voice response (IVR) application, a virtual assistant application, or a guided service application.

15. The method of claim 11, further comprising preprocessing, by the server computing device, the plurality of historical voice call transcripts before executing the combined rule-based and natural language processing machine learning model on the plurality of historical voice call transcripts.

16. The method of claim 15, wherein preprocessing the plurality of historical voice call transcripts comprises:
replacing one or more regular expressions in the historical voice call transcripts with default values;
detecting boundaries between sentences in the historical voice call transcripts; and
inserting punctuation at each sentence boundary in the historical voice call transcripts.

17. The method of claim 16, further comprising executing, by the server computing device, a natural language processing model to replace the regular expressions and the server computing device executes a large language model to detect the boundaries and insert the punctuation.

18. The method of claim 11, wherein the similarity measure algorithm comprises a k-means clustering algorithm or an hdbscan algorithm.

19. The method of claim 11, wherein the conversation flow graph comprises a data structure with a plurality of nodes connected via edges and arranged according to the sequence of cluster identification labels.

20. The method of claim 11, further comprising merging, by the server computing device, at least two of the conversation flow graphs to generate an aggregate conversation flow graph.
